(19) United States
(12) Patent Application Publication
(10) Pub. No.: US 2023/0373544 A1
(43) Pub. Date: Nov. 23, 2023

(54) APPARATUS AND METHOD FOR CONTROLLING TRAIN IN WIRELESS COMMUNICATION SYSTEM

(71) Applicant: ELECTRONICS AND TELECOMMUNICATIONS RESEARCH INSTITUTE, Daejeon (KR)

(72) Inventors: Byungsik YOON, Daejeon (KR); Sang Chul OH, Daejeon (KR); Sook Jin LEE, Daejeon (KR); Min Suk CHOI, Daejeon (KR)

(21) Appl. No.: 18/198,381

(22) Filed: May 17, 2023

(30) Foreign Application Priority Data
May 17, 2022 (KR) 10-2022-0060363
Apr. 19, 2023 (KR) 10-2023-0051216

(51) Int. Cl. B61L 27/70; H04L 12/46; G08C 17/02; H04L 45/24

(52) U.S. Cl. CPC B61L 27/70; H04L 12/4641; G08C 17/02; H04L 45/24; G08C 2201/42; B61L 2205/00

(57) ABSTRACT

Provided is a method of operating a network device for train control in a wireless communication system, the method including: generating control information for train control; providing a first control command to a first base station through a first interface based on the control information; and providing a second control command to a second base station through a second interface based on the control information, wherein the first control command or the second control command is provided to the first base station or the second base station through the first interface or the second interface via a first core network for train control, and one of the first base station and the second base station is connected to a second core network.

### CROSS-REFERENCE TO RELATED APPLICATIONS

This application claims priority to Korean Patent Applications No. 10-2022-0060363, filed on May 17, 2022, and Korean Patent Applications No. 10-2023-0051216, filed on Apr. 19, 2023, which is hereby incorporated by reference in its entirety.

### BACKGROUND

### 1. Field of the Invention

The present disclosure relates to a technology for train control in a wireless communication system, and more particularly, to a technology for multiple accesses between a plurality of onboard train control terminals and a wayside device when configuring communication redundancy in a wireless communication system for train control.

### 2. Description of Related Art

Recently, wireless communication has been applied in train control, greatly reducing wayside infrastructures, such as track circuits for train control, and introduction of train signal control through moving blockage may remarkably increase line capacity. However, the stability and availability requirements of communication infrastructures for train control are as high as wired communication, and it is difficult to perfectly perform train control based on a single wireless communication infrastructure.

### SUMMARY OF THE INVENTION

The present disclosure is directed to providing a method of configuring a redundancy network, a method of connecting an onboard terminal and a wayside device, and a method for multi-access and communication between multiple terminals and a wayside device with regard to implementing communication redundancy using a commercial Long-Term Evolution (LTE) network in a Long-Term Evolution-railway (LTE-R) based train control wireless communication.

According to an aspect of the present disclosure, there is provided a method of operating a network device for train control in a wireless communication system, the method including: generating control information for train control; providing a first control command to a first base station through a first interface based on the control information; and providing a second control command to a second base station through a second interface based on the control information, wherein the first control command or the second control command is provided to the first base station or the second base station through the first interface or the second interface via a first core network for train control, and one of the first base station and the second base station is connected to a second core network.

The first control command and the second control command may be generated by duplicating the control information.

The second core network may be a commercial network connected to the one of the first base station and the second base station through a commercial interface.

The method may further include: acquiring a third control command from the first base station through the first interface; acquiring a fourth control command from the second base station through the second interface; and determining whether the third control command and the fourth control command are abnormal, wherein the third control command and the fourth control command may be generated from another network device for train control.

The third control command may be acquired through a first router of the network device, the fourth control command may be acquired through a second router of the network device, and the first router and the second router may constitute virtual private network (VPN) tunneling.

The first control command may be provided to the first base station through the first router, the second control command may be provided to the second base station through the second router, and the first router and the second router may transmit or receive signals or data through tunneling with routers corresponding to the other network device.

The other network device may include two or more network devices, the first control command or the second control command may further include header information associated with one of the two or more network devices, and the method may further include providing the first control command or the second control command to a router device corresponding to one of the two or more network devices based on the header information.

According to an aspect of the present disclosure, there is provided a network device for train control in a wireless communication system, the network device including: a transceiver; and at least one controller operatively connected to the transceiver, wherein the at least one controller is configured to: generate control information for train control; provide a first control command to a first base station through a first interface based on the control information; and provide a second control command to a second base station through a second interface based on the control information, and wherein the first control command or the second control command is provided to the first base station or the second base station through the first interface or the second interface via a first core network for train control, and one of the first base station and the second base station is connected to a second core network.

The first control command and the second control command may be generated by duplicating the control information.

The second core network may be a commercial network connected to the one of the first base station and the second base station through a commercial interface.

The at least one controller may be further configured to: acquire a third control command from the first base station through the first interface; acquire a fourth control command from the second base station through the second interface; and determine whether the third control command and the fourth control command are abnormal, wherein the third control command and the fourth control command may be generated from another network device for train control.

The network device may further include a first router and a second router, wherein the first router acquires the third control command, and the second router may acquire the fourth control command, and the first router and the second router may constitute virtual private network (VPN) tunneling.

The first control command may be provided to the first base station through the first router, the second control command may be provided to the second base station through the second router, and the first router and the second router may transmit or receive signals or data through tunneling with routers corresponding to the other network device.

The other network device may include two or more network devices, the first control command or the second control command may further include header information associated with one of the two or more network devices, and the at least one controller may be configured to provide the first control command or the second control command to a router device corresponding to one of the two or more network devices based on the header information.

According to an aspect of the present disclosure, there is provided a system for train control in a wireless communication system, the system including: an onboard wireless communication device and a wayside wireless communication device, wherein the onboard wireless communication device is configured to: generate control information for train control; provide a first control command to a first base station through a first interface based on the control information; and provide a second control command to a second base station through a second interface based on the control information, and the wayside wireless communication device is configured to: acquire the first control command from the first base station through the first interface; acquire the second control command from the second base station through the second interface; analyze the first control command and the second control command to determine whether the first control command and the second control command are abnormal; and generate an operating signal corresponding to one of the first control command and the second control command that is determined to be normal.

The wayside wireless communication device and the onboard wireless communication device may provide or acquire the first control command or the second control command through virtual private network (VPN) tunneling.

### BRIEF DESCRIPTION OF THE DRAWINGS

FIG. 1 illustrates a redundancy structure of train control wireless communication according to the conventional technology.

FIG. 2 illustrates a method for frequency reuse in a train control wireless communication system according to the conventional technology.

FIG. 3 illustrates a redundancy structure of a wireless communication system according to an embodiment of the present disclosure.

FIG. 4 illustrates a redundancy structure of a wireless communication system according to an embodiment of the present disclosure.

FIG. 5 illustrates an example in which a base station sharing technology is applied to a wireless communication system for train control according to an embodiment of the present disclosure.

FIG. 6 is a block diagram illustrating a wireless communication system for train control according to an embodiment of the present disclosure.

FIG. 7A illustrates a data flow generated by each component included in FIG. 6.

FIG. 7B illustrates a structure of a data packet for data shown in FIG. 7A.

FIG. 8 illustrates an example in which a wireless communication system for train control according to an embodiment of the present disclosure is applied to multiple terminals.

FIG. 9A illustrates a data flow corresponding to a downlink data transmission from a wayside train control system to one onboard train control system (hereinafter referred to as “onboard train control system #1”), and FIG. 9B illustrates a structure of a data packet for data shown in FIG. 9A.

FIG. 10A illustrates a data flow corresponding to a downlink data transmission from a wayside train control system to another onboard train control system.

FIG. 10B illustrates a structure of a data packet for data shown in FIG. 10A.

FIG. 11 is a flowchart showing operations of a wireless communication system for train control according to an embodiment of the present disclosure.

### DETAILED DESCRIPTION OF EXEMPLARY EMBODIMENTS

The phrases “in some embodiments” or “in one embodiment” appearing in various places in this specification do not necessarily all refer to the same embodiments.

Some embodiments of the present disclosure may be represented by functional block configurations and various processing operations. Some or all of these functional blocks may be implemented with various numbers of hardware and/or software configurations that perform particular functions. For example, the functional blocks of the present disclosure may be implemented by one or more microprocessors, or by circuit configurations for a given function. Also, for example, the functional blocks of the present disclosure may be implemented in various programming or scripting languages. The functional blocks may be implemented with algorithms running on one or more processors. In addition, the present disclosure may employ conventional techniques for electronic configuration, signal processing, and/or data processing, and the like. Terms such as “mechanism,” “element,” “means,” and “configuration” and the like are widely used and are not limited to mechanical and physical configurations.

Also, the connection lines or connection members between the components shown in the drawings are merely illustrative of functional connections and/or physical or circuit connections. In actual devices, connections between components may be represented by various functional connections, physical connections, or circuit connections that can be replaced or added.

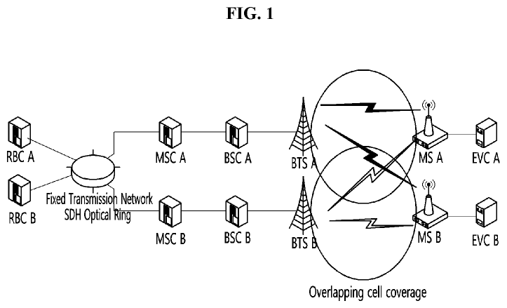

FIG. 1 illustrates a redundancy structure of train control wireless communication according to the conventional technology.

In general, communication infrastructures for train control require as high stability and availability as wired communication, so there are many difficulties in perfectly performing train control based on a single wireless communication infrastructure.

In order to resolve such a limitation, European train control systems have adopted a redundancy structure of train control wireless communication for global system for mobile communications-railway (GSM-R), as shown in FIG. 1.

Referring to FIG. 1, a wireless communication system for train control is provided with exchange centers, base stations, and terminals in a redundancy structure, and when a failure occurs in one of the communication apparatuses, the failing communication apparatus may be immediately replaced with a communication apparatus that is prepared as a backup. Wireless coverage is also configured in a redundancy manner, and thus when a failure occurs in a wireless communication section, a communication terminal prepared as a backup is immediately switched, which is referred as an active-active standby type redundancy.

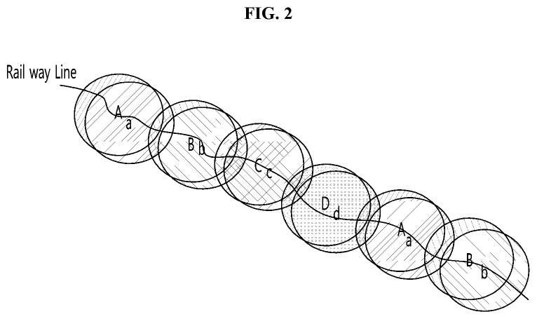

FIG. 2 illustrates a method for frequency reuse in a train control wireless communication system according to the conventional technology.

GSM-R is assigned uplink and downlink bandwidths of 4 MHz and operates nineteen sub-channels each of 200 KHz, and the remaining 200 KHz is finely divided and used as a guard band between the sub-channels. Since GSM-R is based on a time division multiple access (TDMA) scheme, sub-channels used by each base station are not used by adjacent base stations, resulting in a frequency reuse rate set to 8 as shown in FIG. 2. With a frequency usage rate of 8, nineteen sub-channels are divided into small parts, and one base station is assigned two sub-channels.

In GSM-R, as a TDMA system, sub-channels are used without overlapping between base stations. However, in Long-Term Evolution (LTE), which is an orthogonal frequency domain multiple access (OFDMA) system, sub-channels are shared between base stations, so it is impossible to duplicate frequency coverage using the same frequency band without changing the wireless access specifications.

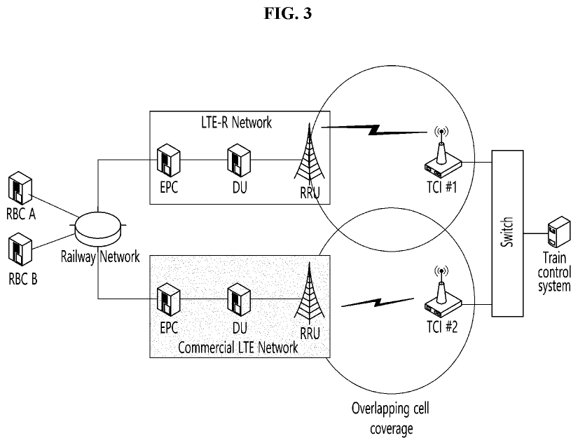

FIG. 3 illustrates a redundancy structure of a wireless communication system according to an embodiment of the present disclosure.

Referring to FIG. 3, through a redundancy structure in which a commercial network system is used together with a train control network system, interference between network systems may be reduced.

Specifically, two LTE-railway (LTE-R) base stations using the same frequency band will inevitably have interference due to the nature of OFDMA using the same subcarrier, but when a commercial network system (e.g., LTE) is used, different frequency bands may be used so that redundancy of train control communication may be achieved.

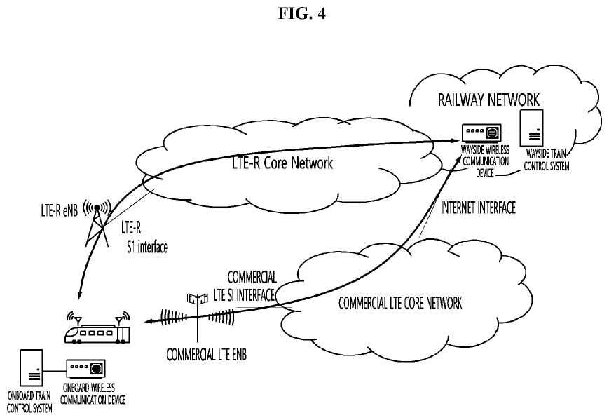

FIG. 4 illustrates a redundancy structure of a wireless communication system according to an embodiment of the present disclosure.

The existing very high frequency (VHF) and trunked radio system (TRS)-based train communication method is being converted to use LTE-R, which is an LTE-based train communication network. As described above, there is a limitation in providing communication availability and stability for train control only with a single LTE-R communication due to the uncertainty of wireless communication.

FIG. 4 illustrates a communication structure formed when train control communication is duplicated using a commercial network system. Wireless-based train control systems may have unpredictable communication failures due to inherent instability of wireless communication, unlike a wired system capable of stable transmission and reception. In particular, when the safety of train operation and the safety of passengers of train control are not ensured as much as wired communication, it may be difficult to commercialize wireless communication-based train control systems. Therefore, a wireless communication-based train control system needs to be constructed with perfect redundancy of communication paths.

Referring to the drawing illustrating redundancy of a train control system using LTE-R and commercial LTE, a communication path from wayside to onboard may be duplicated, so that when a certain apparatus on the communication path fails, the failure may be easily overcome through another path.

However, in this case, a railway communication network needs to be linked to a commercial LTE core network through an Internet interface. This violates the policy of operating the existing railway network as a closed network for safety and security. In addition, even when operating in such a structure, a strong security apparatus may need to be installed at the interface between the Internet network and the railroad network to protect the railroad network, which is a national security facility.

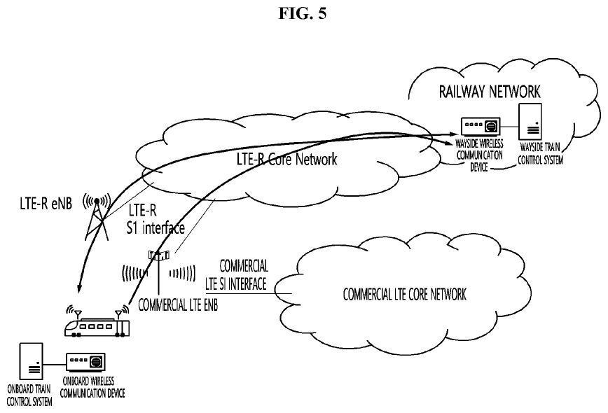

FIG. 5 illustrates an example in which a base station sharing technology is applied to a wireless communication system for train control according to an embodiment of the present disclosure.

In order to construct a network structure that maintains train control communication in a closed network without linking to a commercial Internet network and additionally installing an apparatus, a base station sharing technology (radio access network sharing: RAN sharing) may be used. The base station sharing technology is a technology of sharing one base station to use in different core networks.

Referring to FIG. 5, a commercial LTE eNB may be linked to two core networks, that is, a commercial LTE core network and an LTE-R core network, through S1 interfaces. In this case, the commercial LTE eNB may be leased and utilized as an LTE-R base station. In other words, from a network perspective, the commercial LTE eNB has the same effect of operating on the LTE-R network. When a train control communication redundancy structure is applied using the base station sharing technology, the redundancy is achieved only within the LTE-R network as shown in FIG. 5, so that security-related issues may be resolved while maintaining the existing closed network.

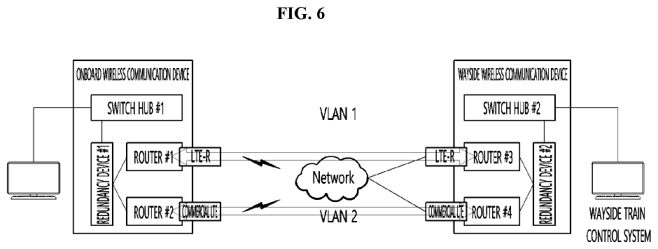

FIG. 6 is a block diagram illustrating a wireless communication system for train control according to an embodiment of the present disclosure.

Referring to FIG. 6, a wireless communication system for train control may include a switching hub, a redundancy device, and a router, forming a redundancy structure.

Wireless communication systems for train control may be divided into a wayside train control system and an onboard train control system depending on the installation location thereof. The wayside train control system or the onboard train control system may include a wayside wireless communication device or an onboard wireless communication device, or may be operatively connected to a wayside wireless communication device or an onboard wireless communication device to transmit or receive signals or data to or from the wayside wireless communication device or the onboard wireless communication device.

In FIG. 6, the switching hub, the redundancy device, the router, and the like forming the redundancy structure may be parts included in the wayside train control system or the onboard train control system. This may be understood similarly in the drawings subsequent to FIG. 6.

For example, train control data generated from an onboard train control system may be transferred to a redundancy device #1 through a switching hub #1, and the redundancy device #1 may copy and duplicate the train control data and transfer the duplicated train control data to each of a router #1 and a router #2. The router #1 having received the train control data may transfer the received train control data to a router #3 through an LTE-R terminal and an Internet service provider #1 (ISP #1) and the train control data may be transferred to a redundancy device #2. This is a transmission path through the LTE-R terminal. As for a transmission path through an LTE terminal, the duplicated train control data from the redundancy device #1 is transferred to the router #2, the router #2 transfers the train control data to a router #4 through the LTE terminal and an ISP #2, and then the train control data may be transferred to the redundancy device #2. The redundancy device #2 may be configured to inspect the two pieces of train control data transferred through different transmission paths for abnormalities, then select one of the pieces of train control data and transfer the selected train control data to a switching hub #2 so that the selected train control data is transferred to the wayside train control system.

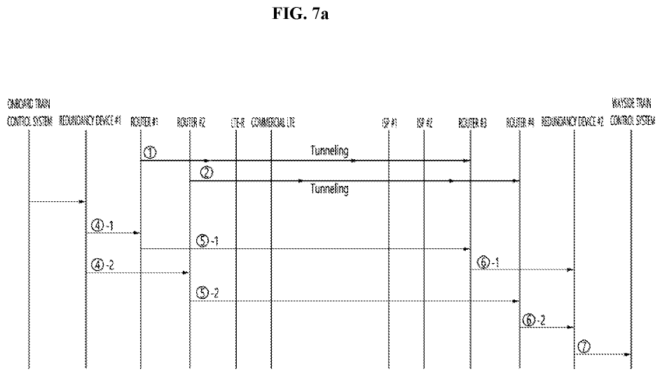

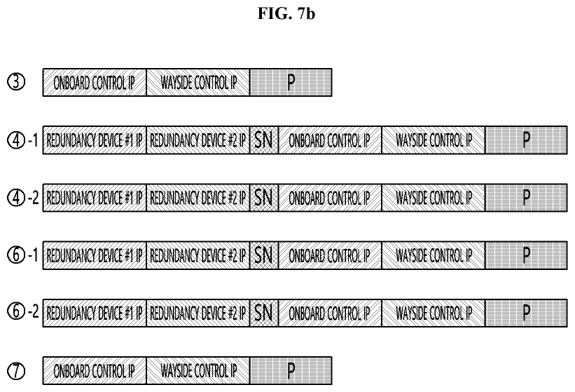

FIG. 7A illustrates a data flow generated by each component included in FIG. 6. FIG. 7B illustrates a structure of a data packet for data shown in FIG. 7A.

First, virtual private network (VPN) tunneling may be configured between a router #1 (a router #2) and a router #3 (a router #4). The reason for configuring VPN tunneling for the section may be for virtualization and tunnel inter-component communication between the router #1 and the router #3 to maintain smooth communication even when Internet protocols (IPs) of the LTE-R terminal and the LTE terminal change. In general, LTE communication terminals may use a variable IP scheme. In other words, the IP may change from time to time with each network connection. In this case, when a call is disconnected during communication and reconnection is performed, the IP of the terminal may change, which causes a communication failure in the train control communication in which a communication session has previously been established. When a virtual network is configured through VPN tunneling, communication may be performable with a virtual address regardless of changes in the IP of the terminal, and data exchange between routers may be performed regardless of intermediate IP addresses through tunneling.

In FIG. 7A, procedures for configuring VPN tunneling between the router #1 and the router #3, and between the router #2 and the router #4 are illustrated as operations \textcircled{1} and \textcircled{3}. An operation \textcircled{3} may be a process of transferring train control data from the onboard train control system to the redundancy device #1. The data packet transferred in the process \textcircled{3} may have a structure shown as \textcircled{3} of FIG. 7B. The data packet is a user datagram protocol (UDP) or a transmission control protocol (TCP) Ethernet packet, and includes a packet head and a payload of train control data. Here, a transmitting end (source: SRC) IP may be an onboard train control device IP, and a receiving end (destination: DST) IP may be a wayside train control device IP. In order for the redundancy device to receive the packet in the process \textcircled{3}, the DST IP needs to be the IP of the redundancy device #1 due to the nature of IP communication. However, since the DST IP of the packet is set to the wayside train control device, the data packet needs to be received using a raw socket. A raw socket is a socket library that allows reception of all Ethernet packets regardless of a packet header. The redundancy device #1 may transfer packets, which are obtained by inserting a sequence number (SN) into the received packet, setting the SRC IP to the IP of the redundancy device #1, and setting the DST IP to the IP of the redundancy device #2, to each of the router #1 and the router #2 through process \textcircled{4}-1 and process \textcircled{4}-2. The packets arriving at the router #1 and the router #2 may be caused to arrive at the router #3 and the router #4 through VPN tunneling, arriving with packet structures shown as \textcircled{6}-1 and \textcircled{6}-2 in FIG. 7B. The packets may be transferred to the redundancy device #2, and the redundancy device #2 may discard one of the duplicated packets based on the SN and transfer the remaining packets in a packet structure \textcircled{7} to the wayside train control system.

When the raw socket and VPN tunneling are used as described above, the packet structure \textcircled{3} and the packet structure \textcircled{7} become identical. This is taken to mean that the wireless communication network simply operates as a packet forwarding network, and the onboard train control system and the wayside train control system may be provided with convenience in independent network address management.

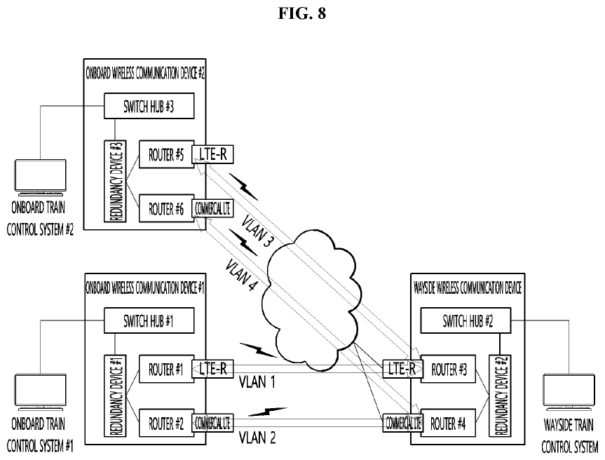

FIG. 8 illustrates an example in which a wireless communication system for train control according to an embodiment of the present disclosure is applied to multiple terminals.

Here, multiple terminals may refer to a case in which the onboard wireless communication device or the wayside wireless communication device is provided in two or more units thereof. In train control communication, there may be cases in which a wayside wireless communication device needs to transmit train control data in linkage with multiple onboard wireless communication devices.

For example, when two onboard wireless communication devices are connected to a network, VPN tunneling may be configured as shown in FIG. 8. A total of four virtual networks (virtual local area networks: VLANs) may be configured and maintained while the train is in operation.

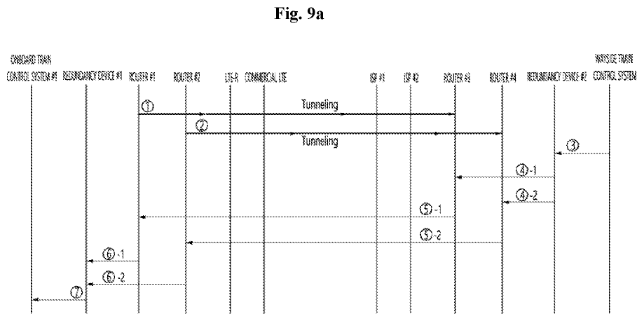

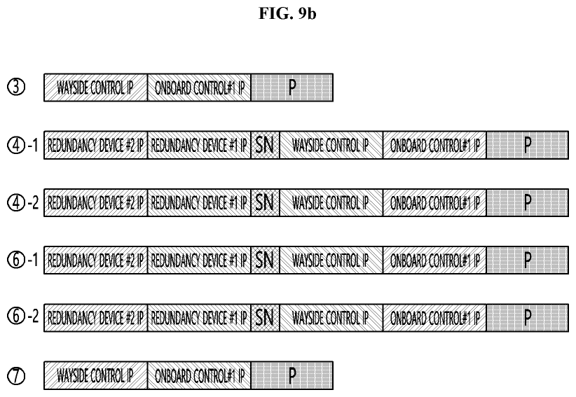

FIG. 9A illustrates a data flow corresponding to a downlink data transmission from a wayside train control system to one onboard train control system (hereinafter referred to as “onboard train control system #1”), and FIG. 9B illustrates a structure of a data packet for data shown in FIG. 9A.

A wayside train control system may transfer train control data to a redundancy device #2 and perform data copy and SN insertion to transfer the received train control data along two routes. In addition, in response to confirming that the train control data is transmitted to an IP address of the onboard control system #1, the wayside train control system may configure data packets by adding an IP header having an IP address of the redundancy device #1 as a receiver, and transfer the data packets to each of the router #3 and the router #4.

The router #3 may check the received IP address header and determine whether to transfer the data through a tunnel of a first VLAN or a tunnel of a third VLAN. In this case, the wayside train control system may, upon checking that the packet is to be transferred to the redundancy device #1, transfer the data through the tunnel of the first VLAN.

The router #4 may check the received IP address header and determine whether to transfer the data through a tunnel of a second VLAN or a tunnel of a fourth VLAN. In this case, the wayside train control system may, upon checking that the packet is to be transferred to the redundancy device #1, transfer the data through the tunnel of the second VLAN.

At the router #1 and the router #2, the train control data transmitted to the respective tunnels may be transferred to the redundancy device #1, and the redundancy device #1 may discard one of the duplicated two packets of train control data based on the SN, and finally transmit the remaining train control data to the onboard train control system #1.

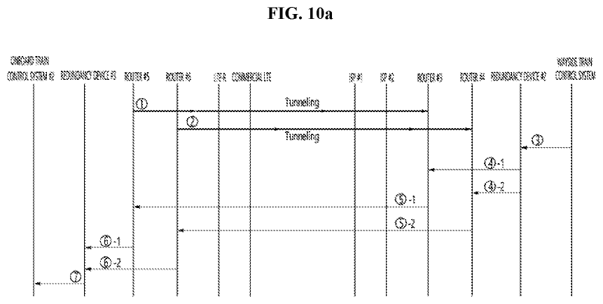

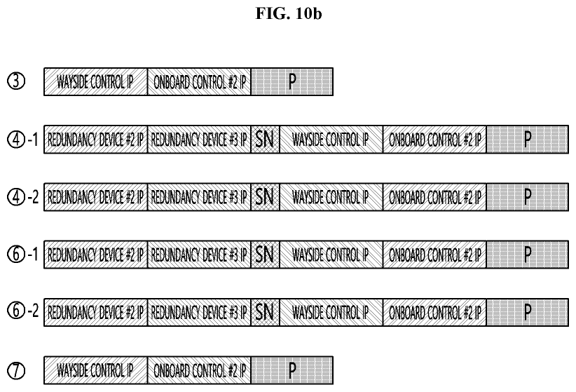

FIG. 10A illustrates a data flow corresponding to a downlink data transmission from a wayside train control system to another onboard train control system (hereinafter referred to as “an onboard train control system #2”). FIG. 10B illustrates a structure of a data packet for the data shown in FIG. 10A.

A wayside train control system may transfer train control data to a redundancy device #2 and perform data copy and SN insertion to transfer the received train control data along two routes. In addition, in response to confirming that the train control data is transmitted to an IP address of the onboard control system #2, the wayside train control system may configure data packets by adding an IP header having an IP address of the redundancy device #3 as a receiver, and transfer the data packets to each of the router #3 and the router #4. For the router #3, the wayside train control system may check the received IP address header and determine whether to transfer the data through a tunnel of the first VLAN or a tunnel of the third VLAN. In this case, the wayside train control system may, upon checking that the packet is to be transferred to the redundancy device #3, transfer the data through the tunnel of the third VLAN.

The router #4 may check the received IP address header and determine whether to transfer the data through a tunnel of the second VLAN or a tunnel of the fourth VLAN. In this case, the wayside train control system may, upon checking that the packet is to be transferred to the redundancy device #3, transfer the data through the tunnel of the fourth VLAN.

At the router #5 and the router #6, the train control data transmitted with the respective tunnels may be transferred to the redundancy device #3, and the redundancy device #3 may discard one of the duplicated two packets of train control data based on the SN, and finally transmit the remaining train control data to the onboard train control system #2.

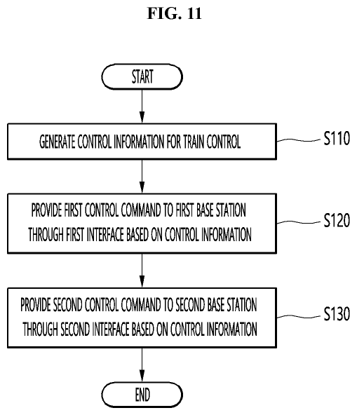

FIG. 11 is a flowchart showing operation of a wireless communication system for train control according to an embodiment of the present disclosure.

Referring to FIG. 11, an operation of a wireless communication system may be described based on an operation of a network device related to at least one of a wayside wireless communication device or an onboard wireless communication device.

In operation S110, the network device generates control information for train control.

The control information may be basic information for generating at least one of a first control command or a second control command to be described below. In addition, according to an embodiment of the present disclosure, the control information may further include data. For example, the network device may generate or acquire data along with control information.

In operation S120, the network device provides a first control command to a first base station through a first interface based on the control information. A first control command or a second control command may be provided to a first base station or a second base station through a first interface or a second interface via a first core network for train control.

One of the first base station and the second base station may be connected to a second core network. Here, the second core network may be a commercial network connected to one of the first base station and the second base station through a commercial interface. For example, when the first core network is an LTE-R network, the second core network may be a commercial LTE network. In addition, the first control command and the second control command may be control commands generated by duplicating the control information.

The network device may provide data regarding the first base station along with the first control command to the first base station through the first interface.

In operation S130, the network device provides the second control command to the second base station through the second interface based on the control information.

The network device may provide data regarding the second base station along with the second control command to the second base station through the second interface.

The network device may further perform operations described below independently of the above-described operations.

The network device may acquire a third control command from the first base station through the first interface. In addition, the network device may acquire a fourth control command from the second base station through the second interface. Here, the third control command and the fourth control command may be control commands that are generated and provided through another network device.

The third control command may be acquired through a first router of the network device, the fourth control command may be acquired through a second router of the network device, and the first router and the second router may compose VPN tunneling.

In addition, the first control command may be provided to the first base station through the first router, the second control command may be provided to the second base station through the second router, and the first router and the second router may be configured to transmit or receive signals or data through tunneling with routers corresponding to the other network device.

Then, the network device may determine whether the third control command and the fourth control command are abnormal.

The above-described embodiment relates to an environment in which only one other network device is present, but there may be two or more other network devices according to various embodiments of the present disclosure.

In this case, the first control command or the second control command may further include header information associated with one of the two or more network devices, and the first control command or the second control command may be provided to a router device corresponding to one of the two or more network devices based on the header information.

As is apparent from the above, the present disclosure provides a solution to overcome security issues that can occur when communication redundancy is implemented in a wireless communication system for train control using a base station sharing method.

In addition, the present disclosure enables efficient and simple processing of transmitted and received input/output packets through a raw socket technique and a virtual private network (VPN) tunneling technique, and even with communication interruption and reconnection, overcomes communication issues through a virtual network using a variable terminal Internet protocol (IP).

In addition, the present disclosure proposes a method of determining a communication path based on packet header received IP information even in a multi-access communication environment of terminals, thereby providing a technology capable of enabling smooth uplink/downlink communication even in a multi-access environment.

As described above, the embodiment of the present invention is not implemented only through the above-described apparatus and/or method, but through a program for realizing a function corresponding to the configuration of the embodiment of the present invention, a recording medium on which the program is recorded, and the like.

Although the embodiments of the present invention have been described in detail above, the scope of the present invention is not limited thereto, and various modifications and improvements performed by those skilled in the art using the basic concepts of the present invention defined in the following claims also belong to the scope of rights of the present invention.

The above are specific embodiments for carrying out the present disclosure. The present disclosure will include not only the above-described embodiments, but also simple design changes or easily changeable embodiments. In addition, the present disclosure will include techniques that may be easily modified and implemented using the embodiments. Accordingly, the scope of the present disclosure should not be limited to the above-described embodiments, but should be defined by the claims and equivalents of the present invention as well as the claims to be described below.

What is claimed is:

1. A method of operating a network device for train control in a wireless communication system, the method comprising:
generating control information for train control;
providing a first control command to a first base station through a first interface based on the control information; and
providing a second control command to a second base station through a second interface based on the control information,
wherein the first control command or the second control command is provided to the first base station or the second base station through the first interface or the second interface via a first core network for train control, and
one of the first base station and the second base station is connected to a second core network.

2. The method of claim 1, wherein the first control command and the second control command are generated by duplicating the control information.

3. The method of claim 1, wherein the second core network is a commercial network connected to the one of the first base station and the second base station through a commercial interface.

4. The method of claim 1, further comprising:
acquiring a third control command from the first base station through the first interface;
acquiring a fourth control command from the second base station through the second interface; and
determining whether the third control command and the fourth control command are abnormal,
wherein the third control command and the fourth control command are generated from another network device for train control.

5. The method of claim 4, wherein the third control command is acquired through a first router of the network device,
the fourth control command is acquired through a second router of the network device, and
the first router and the second router constitute virtual private network (VPN) tunneling.

6. The method of claim 5, wherein the first control command is provided to the first base station through the first router,
the second control command is provided to the second base station through the second router, and
the first router and the second router transmit or receive signals or data through tunneling with routers corresponding to the other network device.

7. The method of claim 5, wherein the other network device includes two or more network devices,
the first control command or the second control command further includes header information associated with one of the two or more network devices, and
the method further includes providing the first control command or the second control command to a router device corresponding to one of the two or more network devices based on the header information.

8. A network device for train control in a wireless communication system, the network device comprising:
a transceiver; and
at least one controller operatively connected to the transceiver,
wherein the at least one controller is configured to:
generate control information for train control;
provide a first control command to a first base station through a first interface based on the control information; and
provide a second control command to a second base station through a second interface based on the control information, and
wherein the first control command or the second control command is provided to the first base station or the second base station through the first interface or the second interface via a first core network for train control, and
one of the first base station and the second base station is connected to a second core network.

9. The network device of claim 8, wherein the first control command and the second control command are generated by duplicating the control information.

10. The network device of claim 8, wherein the second core network is a commercial network connected to the one of the first base station and the second base station through a commercial interface.

11. The network device of claim 8, wherein the at least one controller is further configured to:
acquire a third control command from the first base station through the first interface;
acquire a fourth control command from the second base station through the second interface; and
determine whether the third control command and the fourth control command are abnormal,
wherein the third control command and the fourth control command are generated from another network device for train control.

12. The network device of claim 11, further comprising a first router and a second router,
wherein the first router acquires the third control command, and the second router acquires the fourth control command, and
the first router and the second router constitute virtual private network (VPN) tunneling.

13. The network device of claim 12, wherein the first control command is provided to the first base station through the first router,
the second control command is provided to the second base station through the second router, and
the first router and the second router transmit or receive signals or data through tunneling with routers corresponding to the other network device.

14. The network device of claim 13, wherein the other network device includes two or more network devices,
the first control command or the second control command further includes header information associated with one of the two or more network devices, and
the at least one controller is configured to provide the first control command or the second control command to a router device corresponding to one of the two or more network devices based on the header information.

15. A system for train control in a wireless communication system, the system comprising:
an onboard wireless communication device and
a wayside wireless communication device,
wherein the onboard wireless communication device is configured to:
generate control information for train control;
provide a first control command to a first base station through a first interface based on the control information; and
provide a second control command to a second base station through a second interface based on the control information, and
the wayside wireless communication device is configured to:
acquire the first control command from the first base station through the first interface;
acquire the second control command from the second base station through the second interface;
analyze the first control command and the second control command to determine whether the first control command and the second control command are abnormal; and
generate an operating signal corresponding to one of the first control command and the second control command that is determined to be normal.

16. The system of claim 15, wherein the wayside wireless communication device and the onboard wireless communication device provide or acquire the first control command or the second control command through virtual private network (VPN) tunneling.
